(19) United States
(12) Patent Application Publication
(10) Pub. No.: US 2025/0126455 A1
(43) Pub. Date: Apr. 17, 2025

(54) METHOD AND SYSTEM FOR RADIO ACCESS TECHNOLOGY TYPE MONITORING EVENT SERVICE

(71) Applicant: Verizon Patent and Licensing Inc., Basking Ridge, NJ (US)

(72) Inventors: Riyaj Uddin Ahmed, Coppell, TX (US); Parry Cornell Booker, Sunnyvale, TX (US); Raghuram Parvataneni, Frisco, TX (US); David Taft, Keller, TX (US)

(21) Appl. No.: 18/484,753

(22) Filed: Oct. 11, 2023

(51) Int. Cl. H04W 8/04; H04W 8/18

(52) U.S. Cl. CPC H04W 8/04; H04W 8/18

(57) ABSTRACT

A method, a network device, a system, and a non-transitory computer-readable storage medium are described in relation to an RAT type monitoring event service. The RAT type monitoring event service may include providing a current RAT type associated with an end device and a network to an application function. The RAT type monitoring event service may also include providing a notification to the application function when the end device changes its RAT type. The current RAT type may be used by the application function to perform a network operation or procedure. The application function may subscribe to a monitoring and event notification associated with the RAT type monitoring event service.

### BACKGROUND

Development and design of networks present certain challenges from a network-side perspective and an end device perspective. For example, Next Generation (NG) wireless networks, such as Fifth Generation New Radio (5G NR) networks are being deployed and are under development. End devices may connect to a radio access network (RAN) according to various types of configurations and may be afforded different quality of service (QOS) levels.

### BRIEF DESCRIPTION OF THE DRAWINGS

FIG. 1 is a diagram illustrating an exemplary environment in which an exemplary embodiment of a radio access technology (RAT) type monitoring event service may be implemented;

FIG. 2 is a diagram illustrating an exemplary process of an exemplary embodiment of the RAT type monitoring event service according to an exemplary scenario;

FIG. 3 is a diagram illustrating another exemplary process of an exemplary embodiment of the RAT type monitoring event service according to an exemplary scenario;

FIGS. 4A and 4B are diagrams illustrating yet another exemplary process of an exemplary embodiment of the RAT type monitoring event service according to an exemplary scenario;

FIGS. 5A and 5B are diagrams illustrating still another exemplary process of an exemplary embodiment of the RAT type monitoring event service according to an exemplary scenario;

FIG. 6 is a diagram illustrating an exemplary process of an exemplary embodiment of the RAT type monitoring event service according to an exemplary scenario;

FIG. 7 is a diagram illustrating another exemplary process of an exemplary embodiment of the RAT type monitoring event service according to an exemplary scenario;

FIG. 8 is a diagram illustrating yet another exemplary process of an exemplary embodiment of the RAT type monitoring event service according to an exemplary scenario;

FIG. 9 is a diagram illustrating still another exemplary process of an exemplary embodiment of the RAT type monitoring event service according to an exemplary scenario;

FIG. 10 is a diagram illustrating exemplary components of a device that may correspond to one or more of the devices illustrated and described herein;

FIG. 11 is a flow diagram illustrating an exemplary process of an exemplary embodiment of the RAT type monitoring event service; and

FIG. 12 is a flow diagram illustrating another exemplary process of an exemplary embodiment of the RAT type monitoring event service.

### DETAILED DESCRIPTION

The following detailed description refers to the accompanying drawings. The same reference numbers in different drawings may identify the same or similar elements. Also, the following detailed description does not limit the invention.

There are challenges for a network device, which may host an application service, such as an application server (AS), an application function (AF), or the like to obtain subscriber monitoring information. For example, the AF may query an enforcement function (EF), such as a network exposure function (NEF), a service capability exposure function (SCEF), or the like to obtain the subscriber monitoring information. However, the AF may not know whether the end device is attached to a Fourth Generation (4G) RAN, 4G core network, 4G RAT or a 5G RAN/NR, a 5G core network, 5G RAT and consequently not know whether to query the SCEF or the NEF.

According to exemplary embodiments, a RAT type monitoring event service is described herein. The RAT type monitoring event service may be applied to a wireless environment. For example, the wireless environment may include a 4G wireless environment, a wireless local area network (WLAN), a 5G wireless environment, and/or a future generation wireless environment, as described herein.

According to an exemplary embodiment, an exposure function, such as a SCEF, a NEF, or another type of network device may include logic of the RAT type monitoring event service, as described herein. According to an exemplary embodiment, the AF may request from the SCEF or the NEF a RAT type currently associated with an end device and/or user (referred to simply as “end device”). According to an exemplary embodiment, in response to receiving the request, the SCEF may generate and transmit a request to a home subscriber server (HSS) According to an exemplary embodiment, the request may include a monitoring event request directed to the RAT type.

According to an exemplary embodiment, the HSS may query its subscriber information of relevance to determine whether the end device is currently attached to a 4G RAN (e.g., E-UTRAN), a WLAN, or another non-5G RAN. If the end device is attached to the 4G RAN or another non-5G RAN, the HSS may generate and transmit a response indicating the RAN type. However, if the end device is not attached to the 4G RAN or another non-5G RAN, the HSS may generate and transmit a query to a unified data management (UDM), which in turn may query a unified data repository (UDR). Based on a result of the query, if the end device is attached to a 5G RAN, the UDR may send the RAT type (e.g., 5G RAN) to the HSS via the UDM. In response to receiving the RAT type, the HSS may generate and transmit a response, which includes the RAT type to the SCEF. If the end device is not attached to the 5G RAN, the UDR may send a RAT type value, such as null value or another suitable string that may indicate that the end device is absent, to the HSS via the UDM. In response to receiving the RAT type, the HSS may generate and transmit a response, which indicates a null value or absent end device, to the SCEF.

According to another exemplary embodiment, in response to receiving the request from the AF, the NEF may generate and transmit a request to a UDM. The UDM may query a UDR. Based on a result of the query, if the end device is attached to a 5G RAN, the UDR may send the RAT type (e.g., 5G or NR) to the HSS via the UDM. In response to receiving the RAT type, the HSS may generate and transmit a response, which includes the RAT type to the SCEF. If the end device is not attached to the 5G RAN, the UDM may generate and transmit a request for RAT type information to the HSS. In response to receiving the RAT type request, the HSS may query its subscription information and provide a response, which may indicate a RAT type (e.g., 4G RAN, WLAN, etc.) or a null value or another suitable string that may indicate that the end device is absent or not attached to the network, to the NEF. In response to receiving the RAT type or absent end device message, the NEF may generate and transmit the response to the AF.

According to exemplary embodiments, the RAT type monitoring event service may include a RAT type change subscription and notification service. For example, when the end device may change RAT type (e.g., switch from a 4G network to a 5G network, switch from a 5G network to a 4G network, etc.), the RAT type change subscription and notification service may provide the RAT type change to the AF. According to another example, the RAT type change subscription and notification service may indicate that the end device is absent. According to an exemplary embodiment, the RAT type change subscription and notification service may include communications involving a subscription information storage device (e.g., an HSS, a UDM, a UDR, an HSS front end (HSS-FE), an HSS database (DB), an Evolved Packet System (EPS) UDR, or the like), a SCEF, a NEF, an AF, and so forth, as described herein.

In view of the foregoing, the RAT type monitoring event service may improve the provisioning of subscriber monitoring events. The RAT type monitoring event service may further provide a mechanism to coordinate the AF with the end device and other intermediary networks, such as the RAN and/or the core network to offer and/or provide an application service, manage congestion, satisfy quality of service (QoS) metrics, and the like.

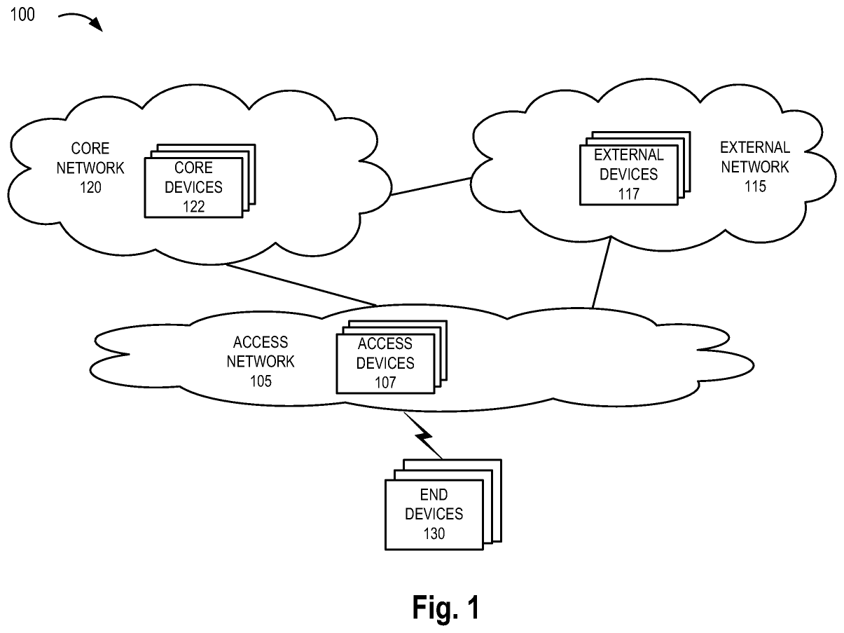

FIG. 1 is a diagram illustrating an exemplary environment 100 in which an exemplary embodiment of an RAT type monitoring event service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the RAT type monitoring event service may use at least one of these planes of communication. Additionally, an interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), etc.) or a new interface of the network device may be provided in order to support the communication (e.g., transmission and reception of messages, information elements (IE), attribute value pairs (AVPs), etc.) between network devices and the RAT type monitoring event service logic of the network device, as described herein. According to various exemplary implementations, the interface of the network device may be a service-based interface, a reference point-based interface, an Open Radio Access Network (O-RAN) interface, or some other type of interface.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to an exemplary embodiment, at least some of external devices 117 may include logic of the RAT type monitoring event service. For example, an AF, an AS, a MEC server, an IP server, an Internet or Web server, or a similar network device that may host an application service (also referred to simply as an AF) may provide an exemplary embodiment of the RAT type monitoring event service, as described herein.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a UDM, a UDR, an authentication server function (AUSF), a security anchor function (SEAF), a network slice selection function (NSSF), a network repository function (NRF), a policy control function (PCF), a network data analytics function (NWDAF), a NEF, a SCEF, a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 may include logic of the RAT type monitoring event service. For example, a NEF, an SCEF, a legacy EF, a future generation EF, or another type of network device may provide an exemplary embodiment of the RAT type monitoring event service, as described herein. According to an exemplary embodiment, the UDM, the UDR, the HSS, the HSS-FE, the EPS UDR, the HSS DB, a legacy subscription storage device (e.g., a home location register (HLR), etc.), a future generation subscription information storage device, or another type of network device may include logic of the RAT type monitoring event service.

According to an exemplary embodiment, the RAT type monitoring event service may include a current RAT type service. For example, the current RAT type service may provide an AF the current RAT type associated with end device 130 of relevance. By way of further example, the current RAT type information may indicate a 4G RAT, a 5G or NR RAT, or absent, as described herein. For purposes of description, the 4G RAT may include a WLAN or another type of non-5G RAT (e.g., Wi-Fi, etc.). According to some exemplary embodiments, the current RAT type data, as described herein may indicate multiple RATs, such as 4G RAT and Wi-Fi.

According to an exemplary embodiment, the RAT type monitoring event service may include a RAT type change subscription and notification service. For example, the RAN type change subscription and notification service may include a subscription and notification service that includes the monitoring and notification of a change to a current RAT type. For example, the RAN type change subscription and notification service may provide an AF the change of the RAT type associated with end device 130 of relevance. By way of further example, the change to RAN type information may indicate a 4G RAT, a 5G or NR RAT, or absent, as described herein.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

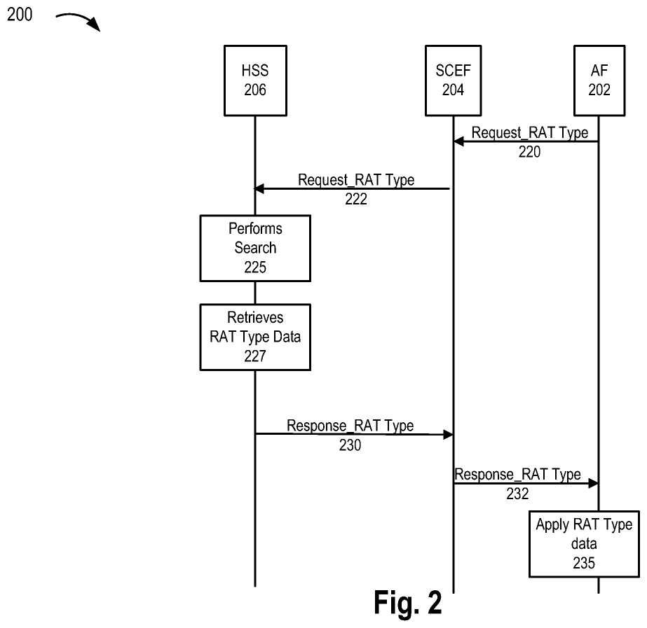

FIG. 2 is a diagram illustrating an exemplary process 200 of an exemplary embodiment of the RAT type monitoring event service. As illustrated, an exemplary environment may include an AF 202, a SCEF 204, and an HSS 206. AF 202 is an exemplary implementation of external device 117. SCEF 204 and HSS 206 are exemplary implementations of core devices 122. According to another exemplary environment, HSS 206 may be implemented according to a split architecture, such as an HSS FE and an EPS UDR or an HSS FE and an HSS DB.

AF 202 may host an application service that may be used by end device 130. For example, the application service may be an application service described in relation to external device 117. According to various exemplary embodiments, AF 202 may be associated with a network operator or similar entity associated with access network 105, core network 120, and/or external network 115, or may be associated with a third party relative to the network operator or similar entity. SCEF 204 and HSS 206 may each provide a function and/or a service in accordance with a network standard, such as 3GPP, 3GPP2, ITU, ETSI, GSMA, or the like and/or of a proprietary nature. AF 202, SCEF 204 and HSS 206 may each include a modified interface or a new interface that supports the communication of a message of the RAT type monitoring event service. According to an exemplary embodiment, AF 202, SCEF 204, and HSS 206 may each include logic of an exemplary embodiment of the RAT type monitoring event service and/or provide support for a process of the RAT type monitoring event service, as described herein. For example, AF 202, SCEF 204 and HSS 206 may each perform a function, an operation, and/or a service based on the message and/or the RAT type monitoring event service beyond a function and/or a service associated with the network standard. For example, SCEF 204 and HSS 206 may perform a function, an operation, or a service that includes identifying a current RAT type pertaining to end device 130 and providing the current RAT type to another network device.

Referring to FIG. 2, AF 202 may generate and transmit a request RAT type message 220 to SCEF 204. According to various exemplary scenarios, AF 202 may generate and/or transmit message 220 before an application service session is established with end device 130, as a part of an establishment of an application service session with end device 130, or during an active application service session with end device 130. The request RAT type message 220 may include data requesting a current RAT type and an identifier of end device 130 (e.g., an international mobile subscriber identity (IMSI) or another unique identifier that identifies end device 130). In response to receiving and reading request RAT type message 220, SCEF 204 may forward request RAT type message 220 or generate and transmit a request RAT type message 222, which may include data requesting a current RAT type and an identifier of end device 130, to HSS 206. In response to receiving and reading request RAT type message 220 or 222, HSS 206 may perform a search 225 in subscription information. According to this example, based on the result of the search, HSS 206 may retrieve RAT type data 227. For example, the RAT type data 227 may indicate that the current RAT type of end device 130 is 4G, a WLAN, or another non-5G network, as described herein. Alternatively, HSS 206 may generate RAT type data 227 to indicate that the current RAT type is that end device 130 is not connected to 4G, the WLAN, etc. (e.g., absent). In response to retrieving the current RAT type, HSS 206 may generate and transmit a response RAT type message 230, which includes the current RAT type data, to SCEF 204. In response to receiving and reading response RAT type message 230, SCEF 204 may forward response RAT type message 230 or generate and transmit a response RAT type message 232 to AF 202. In response to receiving and reading message 230 or 232, AF 202 may apply the RAT type data 235 to an operation or network procedure. For example, AF 202 may use the RAT type data 235 to establish an application session with end device 130 in view of the RAT type (e.g., 4G) and/or to communicate with core device 122 of a 4G core network (e.g., a PCRF, etc.) to obtain policy information applicable to end device 130. According to another example, during an active application session, AF 202 may use the RAT type data 235 to modify or maintain a QoS metric or a QoS Class identifier (QCI) value associated with an application session. According to yet another example, when the RAT type data 235 indicates that end device 130 is absent or not connected to a 4G network, a WLAN, etc., AF 202 may trigger a timer and wait a period of time before initiating another RAT type request and/or may store RAT type data as historical information pertaining to end device 130 and its associated availability, connectivity to a network and corresponding RAT type, etc.

FIG. 2 illustrates an exemplary process 200 of the RAT type monitoring event service, however, according to other exemplary embodiments, the RAT type monitoring event service may perform additional operations, fewer operations, and/or different operations than those illustrated and described in relation to FIG. 2. For example, in response to receiving request RAT type message 222, an HSS-FE (not illustrated) may query an EPS UDR or an HSS DB (also not illustrated) for RAT type data pertaining to end device 130, and based on a result of the query, the HSS-FE may generate and transmit response RAT type message 230 to SCEF 204.

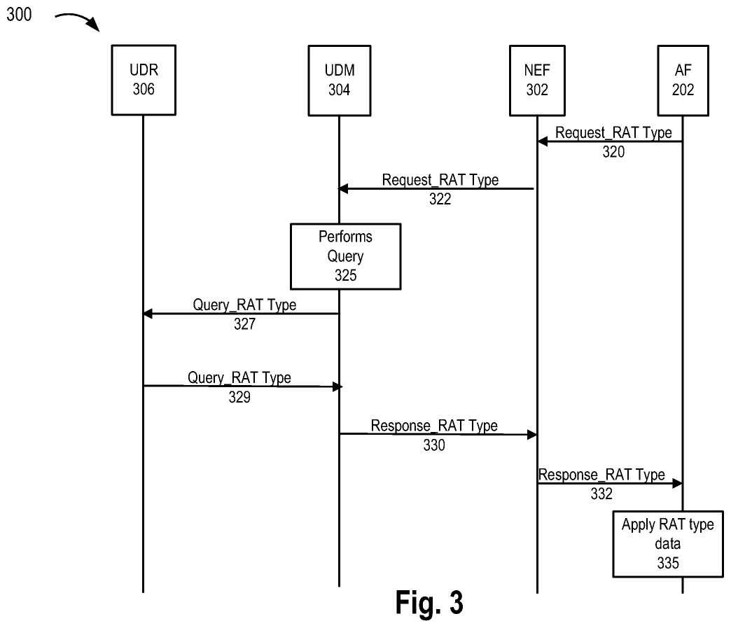

FIG. 3 is a diagram illustrating an exemplary process 300 of an exemplary embodiment of the RAT type monitoring event service. As illustrated, an exemplary environment may include an AF 202, a NEF 302, a UDM 304, and a UDR 306. NEF 302, UDM 304, and UDR 306 are exemplary implementations of core devices 122.

NEF 302, UDM 304, and UDR 306 may each provide a function and/or a service in accordance with a network standard, such as 3GPP, 3GPP2, ITU, ETSI, GSMA, or the like and/or of a proprietary nature. NEF 302, UDM 304, and UDR 306 may each include a modified interface or a new interface that supports the communication of a message of the RAT type monitoring event service. According to an exemplary embodiment, NEF 302, UDM 304, and UDR 306 may each include logic of an exemplary embodiment of the RAT type monitoring event service and/or provide support for a process of the RAT type monitoring event service, as described herein. For example, NEF 302, UDM 304, and UDR 306 may each perform a function, an operation, and/or a service based on the message and/or the RAT type monitoring event service beyond a function and/or a service associated with the network standard. For example, NEF 302, UDM 304, and UDR 306 may perform a function, an operation, or a service that includes identifying a current RAT type pertaining to end device 130 and providing the current RAT type to another network device.

Referring to FIG. 3, AF 202 may generate and transmit a request RAT type message 320 to NEF 302. According to various exemplary scenarios, AF 202 may generate and/or transmit message 320 before an application service session is established with end device 130, as a part of an establishment of an application service session with end device 130, or during an active application service session with end device 130. The request RAT type message 320 may include data requesting a current RAT type and an identifier of end device 130 (e.g., a Globally Unique Temporary Identifier (GUTI), a Subscription Permanent Identifier (SUPI), a Subscription Concealed Identifier (SUCI) a Permanent Equipment Identifier (PEI) or another unique identifier that identifies end device 130). In response to receiving and reading request RAT type message 320, NEF 302 may forward request RAT type message 320 or generate and transmit a request RAT type message 322, which may include data requesting a current RAT type and an identifier of end device 130, to UDM 304. In response to receiving and reading request RAT type message 220 or 222, UDM 304 may perform a query 325. For example, UDM 304 may generate and transmit a query RAT type message 327 to UDR 306. The query RAT type message 327 may include the identifier of end device 130 and data indicating a request for the current RAT type of end device 130. According to this example, based on a result of the query and query RAT type message 329, UDM 304 may retrieve RAT type data. For example, the RAT type data may indicate that the current RAT type of end device 130 is 4G, a WLAN, or another non-5G network, as described herein. Alternatively, UDR 306 may generate RAT type data indicating end device 130 is not connected to 4G, the WLAN, etc. (e.g., absent).

In response to retrieving the current RAT type data, UDM 304 may generate and transmit a response RAT type message 330, which includes the current RAT type data, to NEF 302. In response to receiving and reading response RAT type message 330, NEF 302 may forward response RAT type message 330 or generate and transmit a response RAT type message 332 to AF 202. In response to receiving and reading message 230 or 232, AF 202 may apply the RAT type data 335 to an operation or network procedure. For example, AF 202 may use the RAT type data 335 to establish an application session with end device 130 in view of the RAT type (e.g., 5G) and/or to communicate with core device 122 of a 5G core network (e.g., a PCF, etc.) to obtain policy information applicable to end device 130. According to another example, during an active application session, AF 202 may use the RAT type data 335 to modify or maintain a QoS metric or a 5G QoS Identifier (5QI) value associated with an application session. According to yet another example, when the RAT type data 335 indicates that end device 130 is absent or not connected to a 5G network, AF 202 may trigger a timer and wait a period of time before initiating another RAT type request and/or may store RAT type data as historical information pertaining to end device 130 and its associated availability, connectivity to a network and corresponding RAT type, etc.

FIG. 3 illustrates an exemplary process 300 of the RAT type monitoring event service, however, according to other exemplary embodiments, the RAT type monitoring event service may perform additional operations, fewer operations, and/or different operations than those illustrated and described in relation to FIG. 3.

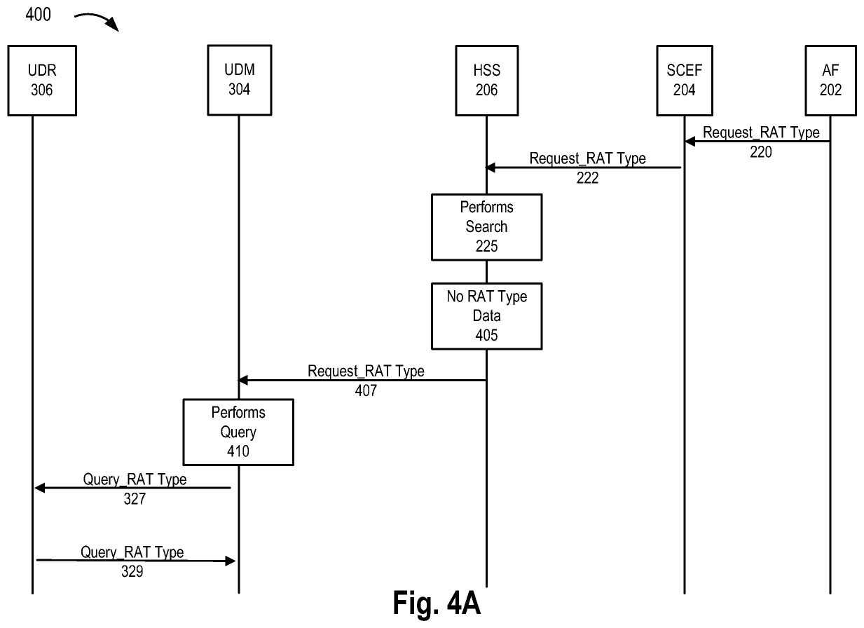

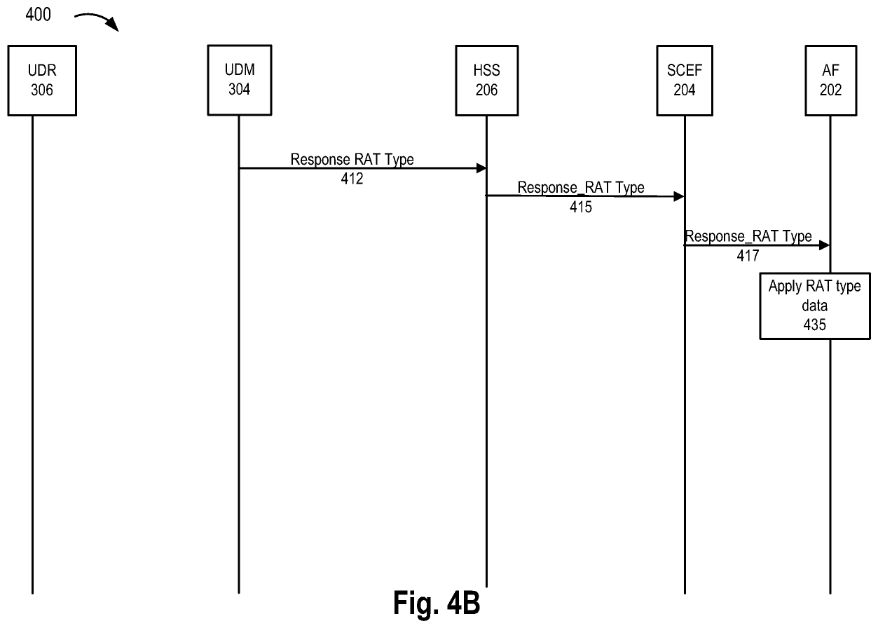

FIGS. 4A and 4B illustrate yet another exemplary process 400 of an exemplary embodiment of the RAT type monitoring event service. As illustrated, an exemplary environment may include an AF 202, SCEF 204, HSS 206, UDM 304, and UDR 306, which have been previously described. As previously described, according to other exemplary environments, HSS 206 may be implemented as an HSS-FE and EPS UDR or an HSS-FE and HSS DB.

Referring to FIG. 4A, the generation and transmission of messages 220 and 222, and performance of a search 225 are steps similar to those previously described and illustrated in relation to FIG. 2 and process 200. According to some exemplary embodiments, however, messages 220 and 222 may include 4G and 5G identifiers of end device 130. For example, message 220 and message 222 may include a SUPI (or another 5G identifier pertaining to end device 130) and an IMSI (or another 4G identifier pertaining to end device 130). According to such an embodiment, in contrast to process 200, when as a result of search 225 where HSS 206 does not find RAT type data pertaining to end device 130 (e.g., end device 130 is absent), HSS 206 does not generate and transmit response RAT type message 230, which includes RAT type data indicating end device 130 is absent, to SCEF 204. Rather, in response to determining that no RAT type data 405, HSS 206 may generate and transmit a request RAT type message 407 (or may forward request RAT type message 222) to UDM 304. According to other exemplary embodiments, HSS 206 may store multiple identifiers of end device 130, and may be configured that when RAT type data indicates that end device 130 is absent, HSS 206 may generate and transmit request RAT type message 407. As a part of the generation of request RAT type message 407, HSS 206 may correlate and/or select a 5G identifier based on another identifier of end device 130.

In response to receiving and reading message 407 or 222, UDM 304 may perform a query 410 in a manner similar to that previously explained in relation to messages 327 and 329 of process 300. Referring to FIG. 4B, in a manner similar to that previously described, response RAT type messages 412, 415, and 417 may carry the current RAT type data (e.g., 5G, absent for both 4G and 5G) of end device 130 and be transmitted to AF 202 by UDM 304, HSS 206, and SCEF 204, respectively, as illustrated. In response to receiving and reading message 417, AF 202 may apply the RAT type data 435 to an operation or network procedure, as described herein. For example, similar to apply RAT type data 335 of process 300, AF 202 may perform similar operations depending on the whether the current RAT type data indicates 5G or absence of end device 130.

FIGS. 4A and 4B illustrate an exemplary process 400 of the RAT type monitoring event service, however, according to other exemplary embodiments, the RAT type monitoring event service may perform additional operations, fewer operations, and/or different operations than those illustrated and described in relation to FIGS. 4A and 4B. For example, UDR 306 may store multiple identifiers of end device 130 (e.g., 4G, 5G, etc.). According to another example, request RAT type message 407 and/or request RAT type message 222 may include only a 4G identifier of end device 130. According to this example, UDR 306 may correlate the 4G identifier to a 5G identifier of end device 130.

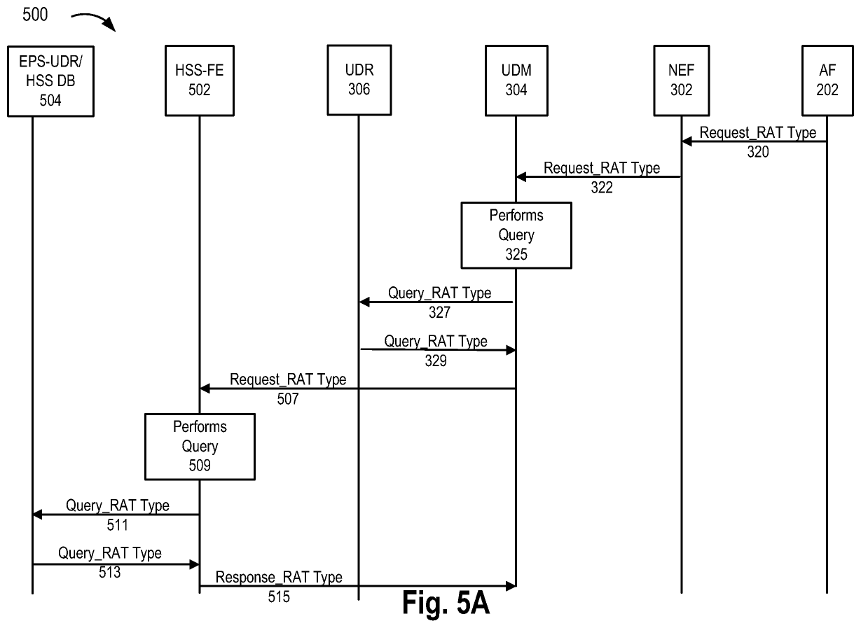

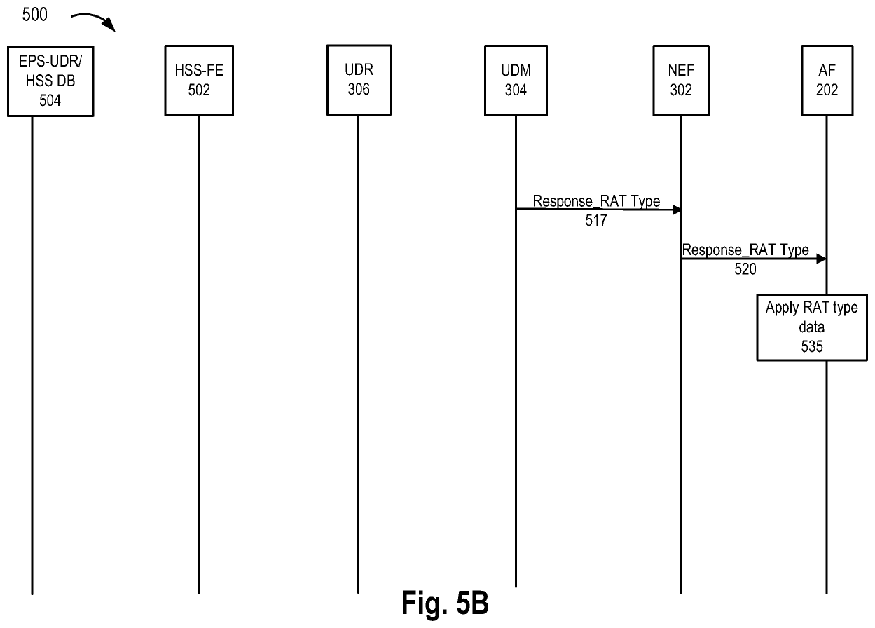

FIGS. 5A and 5B illustrate yet another exemplary process 500 of an exemplary embodiment of the RAT type monitoring event service. As illustrated, an exemplary environment may include an AF 202, SCEF 204, UDM 304, and UDR 306, which have been previously described. Additionally, the environment may include an HSS-FE 502 and an EPS UDR or an HSS 504 (EPS-UDR/HSS DB 504). HSS-FE 502 and EPS-UDR/HSS DB 504 are exemplary implementations of core devices 122.

HSS-FE 502 and EPS-UDR/HSS DB 504 may each provide a function and/or a service in accordance with a network standard, such as 3GPP, 3GPP2, ITU, ETSI, GSMA, or the like and/or of a proprietary nature. HSS-FE 502 and EPS-UDR/HSS DB 504 may each include a modified interface or a new interface that supports the communication of a message of the RAT type monitoring event service. According to an exemplary embodiment, HSS-FE 502 and EPS-UDR/HSS DB 504 may each include logic of an exemplary embodiment of the RAT type monitoring event service and/or provide support for a process of the RAT type monitoring event service, as described herein. For example, HSS-FE 502 and EPS-UDR/HSS DB 504 may each perform a function, an operation, and/or a service based on the message and/or the RAT type monitoring event service beyond a function and/or a service associated with the network standard. For example, HSS-FE 502 and EPS-UDR/HSS DB 504 may perform a function, an operation, or a service that includes identifying a current RAT type pertaining to end device 130 and providing the current RAT type to another network device.

Referring to FIG. 5A, the generation and transmission of messages 320 and 322, and performance of a query 325 are steps similar to those previously described and illustrated in relation to FIG. 3 and process 300, as well as messages 327 and 329. According to some exemplary embodiments, however, messages 320 and 322 may include 4G and 5G identifiers of end device 130. For example, message 220 and message 222 may include a SUPI (or another 5G identifier pertaining to end device 130) and an IMSI (or another 4G identifier pertaining to end device 130). According to such an embodiment, in contrast to process 300, when as a result of query 325 where UDM 304 does not find RAT type data pertaining to end device 130 (e.g., end device 130 is absent), UDM 304 does not generate and transmit response RAT type message 330, which includes RAT type data indicating end device 130 is absent, to NEF 302. Rather, in response to determining the absence of end device 130 not connected or attached to a 5G network, for example, UDM 304 may generate and transmit a request RAT type message 507 (or may forward request RAT type message 322) to HSS-FE 502. According to other exemplary embodiments, UDR 306 may store multiple identifiers of end device 130, and UDM 304 may be configured that when current RAT type data indicates that end device 130 is absent, UDM 304 may generate and transmit request RAT type message 507, which may include the 4G identifier of end device 130. For example, UDR 306 may correlate and/or select a 4G identifier based on another identifier of end device 130, and include the 4G identifier in query RAT type message 329.

In response to receiving and reading message 507 or 322, HSS-FE 502 may perform a query 509 in which query RAT type messages 511 and 513 may be communicated between HSS-FE 502 and EPS-UDR/HSS DB 504. For example, query RAT type message 511 may include the 4G identifier of end device 130 and a request for current RAT type data, and query RAT type message 513 may include 4G identifier and the current RAT type data (e.g., 4G, absent). In response to receiving query RAT type message 513, HSS-FE 502 may generate and transmit a response RAT type message 515, which may include the 4G identifier and the current RAT type data, to UDM 304. Referring to FIG. 5B, in a manner similar to that previously described, response RAT type messages 517 and 520 may carry the current RAT type data (e.g., 4G, absent for both 4G and 5G) of end device 130 and be transmitted to AF 202 by UDM 304 and NEF 302, respectively, as illustrated. In response to receiving and reading message 520, AF 202 may apply the RAT type data 535 to an operation or network procedure, as described herein. For example, similar to apply RAT type data 235 of process 200, AF 202 may perform similar operations depending on the whether the current RAT type data indicates 4G or absence of end device 130.

FIGS. 5A and 5B illustrate an exemplary process 500 of the RAT type monitoring event service, however, according to other exemplary embodiments, the RAT type monitoring event service may perform additional operations, fewer operations, and/or different operations than those illustrated and described in relation to FIGS. 5A and 5B. For example, EPS-UDR/HSS DB 504 may store multiple identifiers of end device 130 (e.g., 4G, 5G, etc.). According to another example, request RAT type message 507 and/or request RAT type message 322 may include only a 5G identifier of end device 130. According to this example, EPS-UDR/HSS DB 504 may correlate the 5G identifier to a 4G identifier of end device 130.

As previously described, the RAT type monitoring event service may include the RAT type change subscription and notification service. For example, end device 130 may move and/or change RAT during a period of time. The AF or another type of network device may want to know when the change of RAT occurs for end device 130.

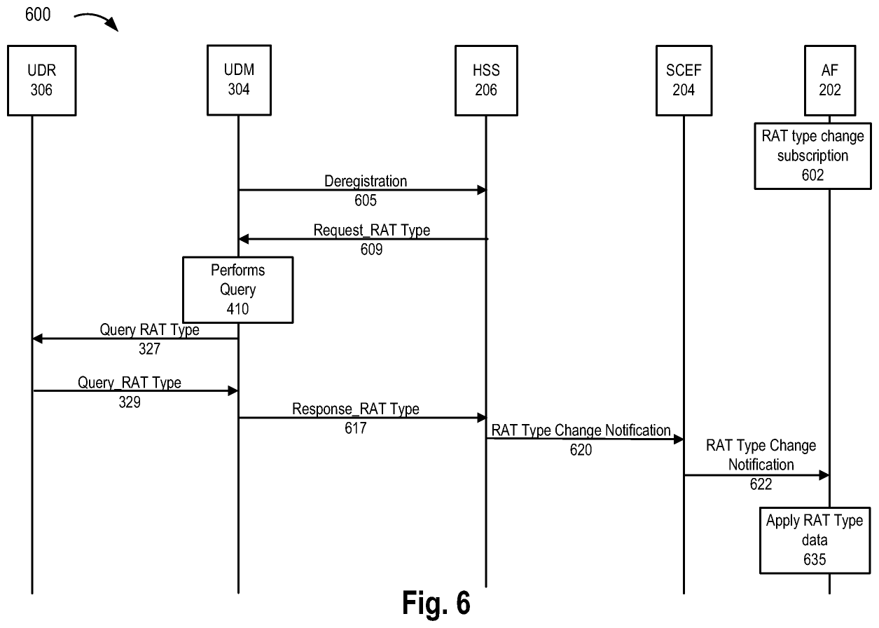

FIG. 6 is a diagram illustrating an exemplary process 600 of an exemplary embodiment of the RAT type monitoring event service. According to other exemplary environments, HSS 206 may be implemented as HSS FE 502. As illustrated, AF 202 may establish a RAT type change subscription 602. For example, the RAT type change subscription may include notification of when end device 130 may change RATs. Although not illustrated, the establishment of the RAT type change subscription may include messages exchanged (not illustrated) between SCEF 204, HSS 206, UDM 304 and other core devices 122 (not illustrated). According to an exemplary scenario, subsequent to the establishment of RAT type change subscription, assume end device 130 may connect to and attach to a 4G network. AF 202 may receive current RAT type data pertaining to end device 130 according to a process, as described herein.

Thereafter, assume that end device 130 may change RATs. For example, a connection between end device 130 and an MME (not illustrated) may change to a connection between end device 130 and an AMF (also not illustrated) or another network/RAT. Based on the change of the current RAT type, UDM 304 may generate and transmit a deregistration message 605 to HSS 206. For example, deregistration message 605 may include data indicating a deregistration of end device 130 and an identifier of end device 130 (e.g., a Nhss_UECM_SNDeregistration). Deregistration message 605 may include other types of data (e.g., access type, removal reason, etc.).

In response to receiving and reading message 605, HSS 206 may generate and transmit a request RAT type message 609 to UDM 304. For example, HSS 206 may be configured to determine if end device 130 has changed its access RAT type from 4G to 5G/NR or another network/RAT. In a manner similar to that previously described, HSS 206 may generate and transmit a request RAT type message 609, which may include an identifier of end device 130 and a request for current RAT type of end device 130, to UDM 304. In response, UDM 304 may perform a query 410, and communicate query RAT type messages 327 and 329 with UDR 306, in a manner similar to that previously described. According to various exemplary scenarios, query RAT type message 329 may include current RAT type data as 5G (e.g., end device 130 is attached or connected) or absent. The current RAT type data may be communicated to AF 202 based on response RAT type message 617, and RAT type change notification messages 620 and 622 (or a forwarding of message 620 by SCEF 204 to AF 202). In response to receiving and reading message 622 (or 620), AF 202 may apply the RAT type data 635 to an operation or network procedure, as described herein. For example, similar to apply RAT type data 335 of process 300, AF 202 may perform similar operations depending on the whether the current RAT type data indicates 5G or absence of end device 130.

FIG. 6 illustrates an exemplary process 600 of the RAT type monitoring event service, however, according to other exemplary embodiments, the RAT type monitoring event service may perform additional operations, fewer operations, and/or different operations than those illustrated and described in relation to FIG. 6.

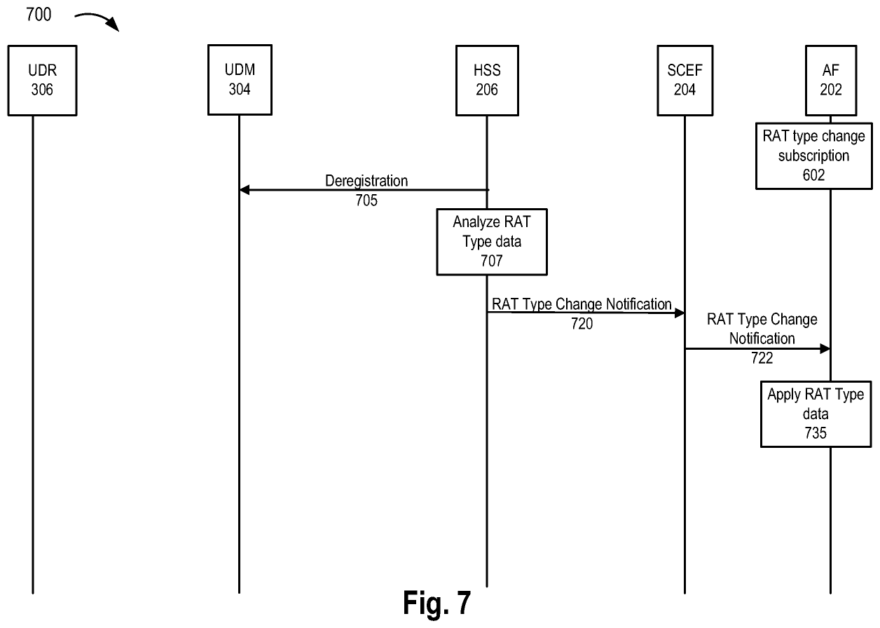

FIG. 7 is a diagram illustrating an exemplary process 700 of an exemplary embodiment of the RAT type monitoring event service. According to other exemplary environments, HSS 206 may be implemented as HSS FE 502. As illustrated, AF 202 may establish a RAT type change subscription 602. For example, the RAT type change subscription may include notification of when end device 130 may change RATs, as previously described. According to an exemplary scenario, subsequent to the establishment of RAT type change subscription, assume end device 130 may connect to and attach to a 5G network. AF 202 may receive current RAT type data pertaining to end device 130 according to a process, as described herein.

Thereafter, assume that end device 130 may change RATs. For example, a connection between end device 130 and an AMF (not illustrated) may change to a connection between end device 130 and an MME (also not illustrated) or another network/RAT. Based on the change of the current RAT type, HSS 206 may generate and transmit a deregistration message 705 to UDM 304. For example, deregistration message 705 may include data indicating a deregistration of end device 130 and an identifier of end device 130 (e.g., an AMF Deregistration Request). Deregistration message 705 may include other types of data (e.g., access type, removal reason, etc.).

HSS 206 may analyze subscription information of relevance to end device 130 to determine current RAT type data 707. For example, end device 130 may connect or attach to a 4G network or be absent. In either case, HSS 206 may generate and transmit a RAT type change notification message 720, which may indicate the RAT type as 4G or absent and the identifier of end device 130, to SCEF 204. SCEF 204 may generate and transmit a RAT type change notification message 722 (or forward message 720) to AF 202. In response to receiving and reading message 722 or 720, AF 202 may apply the RAT type data 735 to an operation or network procedure, as described herein. For example, similar to apply RAT type data 235 of process 200, AF 202 may perform similar operations depending on the whether the current RAT type data indicates 4G or absence of end device 130.

FIG. 7 illustrates an exemplary process 700 of the RAT type monitoring event service, however, according to other exemplary embodiments, the RAT type monitoring event service may perform additional operations, fewer operations, and/or different operations than those illustrated and described in relation to FIG. 7.

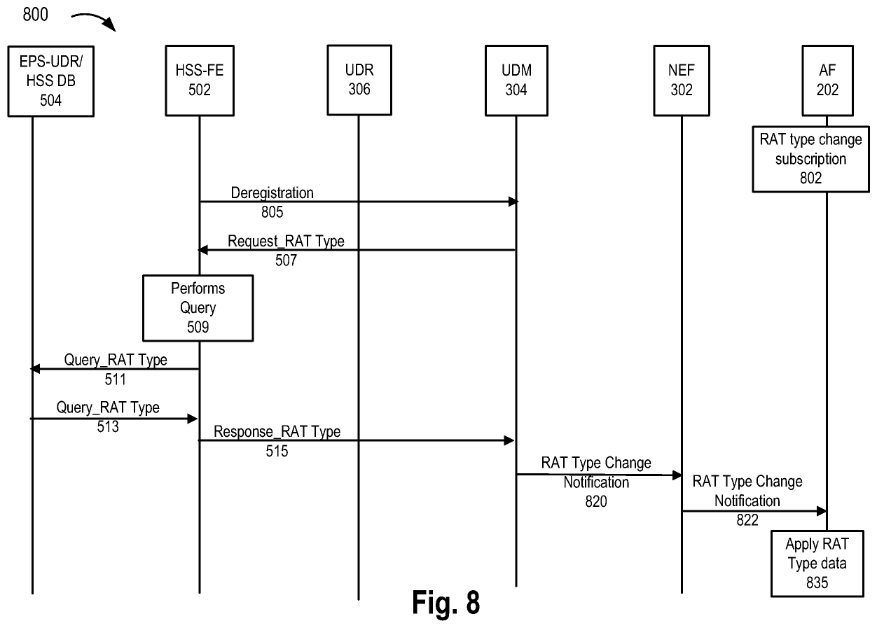

FIG. 8 is a diagram illustrating an exemplary process 800 of an exemplary embodiment of the RAT type monitoring event service. According to other exemplary environments, HSS FE 502 and EPS-UDR/HSS DB 503 may be implemented as HSS 206. As illustrated, AF 202 may establish a RAT type change subscription 802. For example, the RAT type change subscription may include notification of when end device 130 may change RATs, as previously described. Although not illustrated, the establishment of the RAT type change subscription may include messages exchanged (not illustrated) between AF 202, NEF 302, UDM 304, UDR 306, HSS-FE 502, EPS-UDR/HSS DB 504 and other core devices 122 (not illustrated). According to an exemplary scenario, subsequent to the establishment of RAT type change subscription, assume end device 130 may connect to and attach to a 5G network. AF 202 may receive current RAT type data pertaining to end device 130 according to a process, as described herein.

Thereafter, assume that end device 130 may change RATs. For example, a connection between end device 130 and an AMF (not illustrated) may change to a connection between end device 130 and an MME (also not illustrated) or another network/RAT. Based on the change of the current RAT type, HSS-FE 502 may generate and transmit a deregistration message 805 to UDM 304. For example, deregistration message 805 may include data indicating a deregistration of end device 130 and an identifier of end device 130 (e.g., an AMF Deregistration Request). Deregistration message 805 may include other types of data (e.g., access type, removal reason, etc.).

In response to receiving and reading message 805, UDM 304 may generate and transmit a message requesting the current RAT type of end device 130 to HSS-FE 502. For example, UDM 304 may be configured to determine if end device 130 has changed its access RAT type from 5G to 4G or another network/RAT. For example, the requesting of the current RAT type between UDM 304 may include messages similar to those previously described in relation to process 500. For example, UDM 304 may generate and transmit request RAT type message 507 to HSS-FE 502. In response to receiving and reading message 507, HSS-FE 502 may perform a query 509 in which query RAT type messages 511 and 513 may be communicated between HSS-FE 502 and EPS-UDR/HSS DB 504. For example, query RAT type message 511 may include the 5G identifier and/or the 4G of end device 130 and a request for current RAT type data, and query RAT type message 513 may include the 4G identifier and/or the 5G identifier of end device 130 and the current RAT type data (e.g., 4G, absent). In response to receiving query RAT type message 513, HSS-FE 502 may generate and transmit a response RAT type message 515, which may include the 4G identifier and/or the 5G identifier and the current RAT type data, to UDM 304.

The current RAT type data and end device identifier may be communicated to AF 202 based on RAT type change notification messages 820 and 822 (or a forwarding of message 820 by NEF 302 to AF 202). In response to receiving and reading message 822 or 820, AF 202 may apply the RAT type data 835 to an operation or network procedure, as described herein. For example, similar to apply RAT type data 335 of process 300, AF 202 may perform similar operations depending on the whether the current RAT type data indicates 4G or absence of end device 130.

FIG. 8 illustrates an exemplary process 800 of the RAT type monitoring event service, however, according to other exemplary embodiments, the RAT type monitoring event service may perform additional operations, fewer operations, and/or different operations than those illustrated and described in relation to FIG. 8.

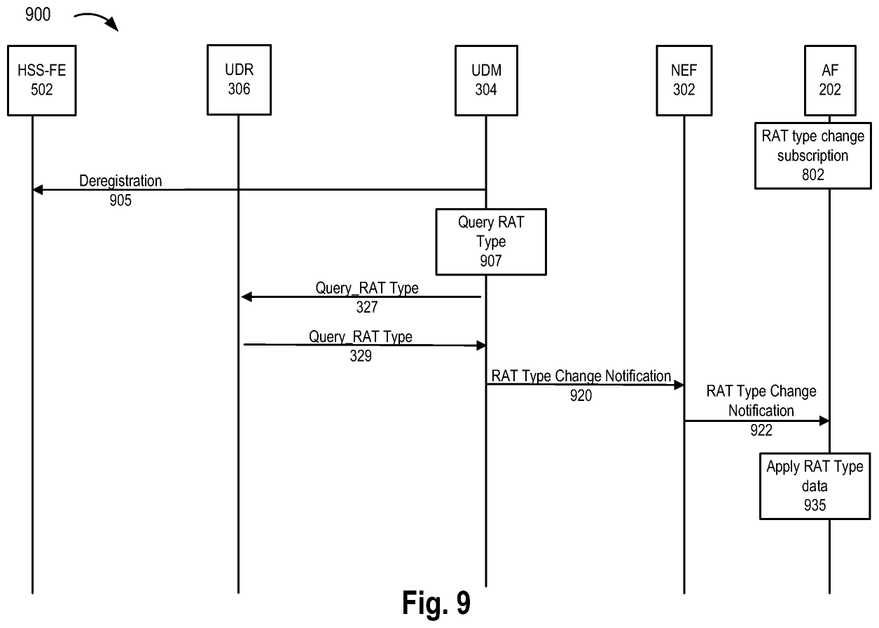

FIG. 9 is a diagram illustrating still another exemplary process 900 of an exemplary embodiment of the RAT type monitoring event service. According to other exemplary environments, HSS FE 502 may be implemented as HSS 206. As illustrated, AF 202 may establish a RAT type change subscription 802. For example, the RAT type change subscription may include notification of when end device 130 may change RATs, as previously described. According to an exemplary scenario, subsequent to the establishment of RAT type change subscription, assume end device 130 may connect to and attach to a 4G network. AF 202 may receive current RAT type data pertaining to end device 130 according to a process, as described herein.

Thereafter, assume that end device 130 may change RATs. For example, a connection between end device 130 and an MME (not illustrated) may change to a connection between end device 130 and an AMF (also not illustrated) or another network/RAT. Based on the change of the current RAT type, UDM 304 may generate and transmit a deregistration message 905 to HSS-FE 502. For example, deregistration message 905 may include data indicating a deregistration of end device 130 and an identifier of end device 130 (e.g., a Nhss_UECM_SNDeregistration). Deregistration message 705 may include other types of data (e.g., access type, removal reason, etc.).

Based on the current RAT type change, UDM 304 may perform a query RAT type 907 procedure. For example, in manner similar to the previously described in relation to process 300, UDM 304 and UDR 306 may communicate query RAT type messages 327 and 329. For example, end device 130 may connect or attach to a 5G network or be absent. Based on query RAT type message 329, UDM 304 may generate and transmit a RAT type change notification message 920, which may indicate the RAT type as 5G or absent and the identifier of end device 130, to NEF 302. NEF 302 may generate and transmit a RAT type change notification message 922 (or forward message 920) to AF 202. In response to receiving and reading message 922 or 920, AF 202 may apply the RAT type data 935 to an operation or network procedure, as described herein. For example, similar to apply RAT type data 335 of process 300, AF 202 may perform similar operations depending on the whether the current RAT type data indicates 5G or absence of end device 130.

FIG. 9 illustrates an exemplary process 900 of the RAT type monitoring event service, however, according to other exemplary embodiments, the RAT type monitoring event service may perform additional operations, fewer operations, and/or different operations than those illustrated and described in relation to FIG. 9.

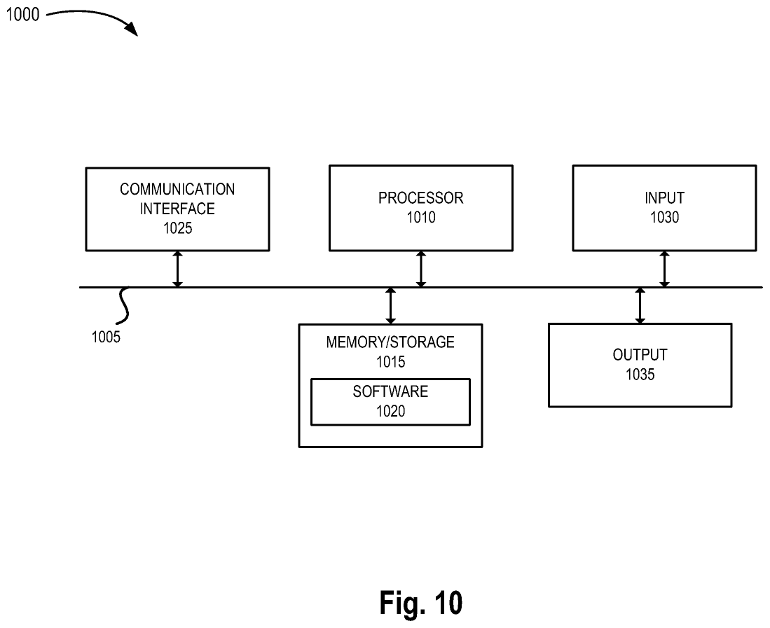

FIG. 10 is a diagram illustrating exemplary components of a device 1000 that may be included in one or more of the devices described herein. For example, device 1000 may correspond to access device 107, external device 117, core device 122, end device 130, and/or other types of devices, as described herein. As illustrated in FIG. 10, device 1000 includes a bus 1005, a processor 1010, a memory/storage 1015 that stores software 1020, a communication interface 1025, an input 1030, and an output 1035. According to other embodiments, device 1000 may include fewer components, additional components, different components, and/or a different arrangement of components than those illustrated in FIG. 10 and described herein.

Bus 1005 includes a path that permits communication among the components of device 1000. For example, bus 1005 may include a system bus, an address bus, a data bus, and/or a control bus. Bus 1005 may also include bus drivers, bus arbiters, bus interfaces, clocks, and so forth.

Processor 1010 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 1010 may be implemented as hardware (e.g., a microprocessor, etc.), a combination of hardware and software (e.g., a SoC, an ASIC, etc.), may include one or multiple memories (e.g., cache, etc.), etc.

Processor 1010 may control the overall operation, or a portion of operation(s) performed by device 1000. Processor 1010 may perform one or multiple operations based on an operating system and/or various applications or computer programs (e.g., software 1020). Processor 1010 may access instructions from memory/storage 1015, from other components of device 1000, and/or from a source external to device 1000 (e.g., a network, another device, etc.). Processor 1010 may perform an operation and/or a process based on various techniques including, for example, multithreading, parallel processing, pipelining, interleaving, learning, model-based, etc.

Memory/storage 1015 includes one or multiple memories and/or one or multiple other types of storage mediums. For example, memory/storage 1015 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 1015 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 1015 may be external to and/or removable from device 1000, such as, for example, a Universal Serial Bus (USB) memory stick, a dongle, a hard disk, mass storage, off-line storage, or some other type of storing medium. Memory/storage 1015 may store data, software, and/or instructions related to the operation of device 1000.

Software 1020 includes an application or a program that provides a function and/or a process. As an example, with reference to core device 122 (e.g., SCEF 204, HSS 206, NEF 302, UDM 304, UDR 306, HSS-FE 502, EPS-UDR/HSS DB 504, etc.), software 1020 may include an application that, when executed by processor 1010, provides a function and/or a process of the RAT type monitoring event service, as described herein. Software 1020 may also include firmware, middleware, microcode, hardware description language (HDL), and/or another form of instruction. Software 1020 may also be virtualized. Software 1020 may further include an operating system (OS) (e.g., Windows, Linux, Android, proprietary, etc.).

Communication interface 1025 permits device 1000 to communicate with other devices, networks, systems, and/or the like. Communication interface 1025 includes one or multiple wireless interfaces, optical interfaces, and/or wired interfaces. For example, communication interface 1025 may include one or multiple transmitters and receivers, or transceivers. Communication interface 1025 may operate according to a protocol stack and a communication standard. Communication interface 1025 may support one or multiple MIMO, beamforming, and/or transmission/reception configurations.

Input 1030 permits an input into device 1000. For example, input 1030 may include a keyboard, a mouse, a display, a touchscreen, a touchless screen, a button, a switch, an input port, speech recognition logic, and/or some other type of visual, auditory, tactile, affective, olfactory, etc., input component. Output 1035 permits an output from device 1000. For example, output 1035 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 1000 may be implemented in the same manner. For example, device 1000 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 1000 may be configured to perform a process and/or a function, as described herein, in response to processor 1010 executing software 1020 stored by memory/storage 1015. By way of example, instructions may be read into memory/storage 1015 from another memory/storage 1015 (not shown) or read from another device (not shown) via communication interface 1025. The instructions stored by memory/storage 1015 cause processor 1010 to perform a function, an operation, or a process described herein. Alternatively, for example, according to other implementations, device 1000 may be configured to perform a function, an operation, or a process described herein based on the execution of hardware (processor 1010, etc.).

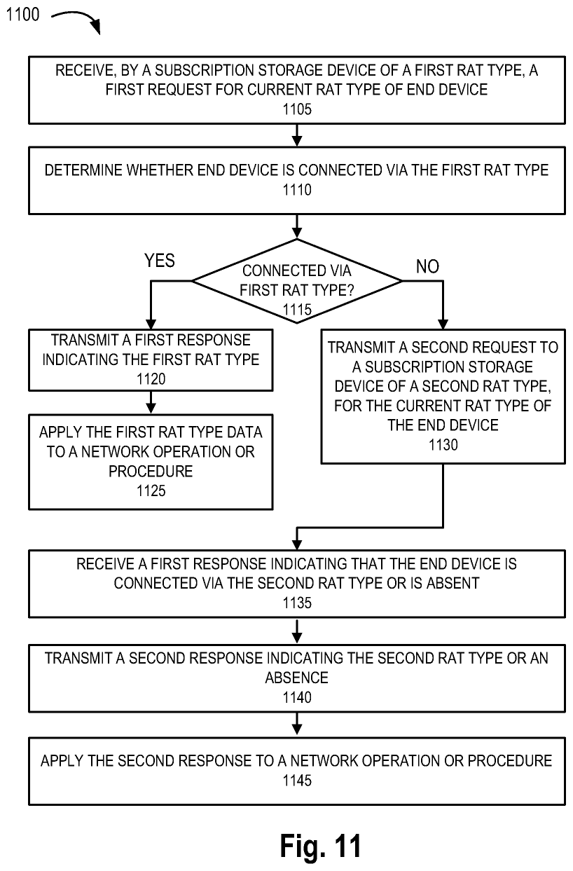

FIG. 11 is a flow diagram illustrating an exemplary process 1100 of an exemplary embodiment of the RAT type monitoring event service. According to an exemplary embodiment, core devices 122 may perform operations of process 1100. For example, subscription storage devices associated with a first and a second RAT type, such as HSS 206, UDM 304, UDR 306, HSS-FE 502, or the like, may perform operations or steps of process 1100. According to an exemplary implementation, processor 1010 executes software 1020 to perform a step (in whole or in part) of process 1100, as described herein. Alternatively, a step (in whole or in part) may be performed by execution of only hardware. For purposes of description only, operations of process 1100 are described as being performed by a subscription storage device of a first RAT type. Process 1100 may include operation illustrated and described in relation to FIGS. 2, 3, 4A, 4B, 5A, and 5B, and elsewhere in this description.

Referring to FIG. 11, in block 1105, the subscription storage device of the first RAT type may receive a first request for a current RAT type of end device 130. For example, the first request may be received from an AF via an exposure function (EF).

In block 1110, the subscription storage device of the first RAT type may determine whether end device 130 is connected via the first RAT type. For example, the subscription storage device of the first RAT type may query its subscription information to identify or determine a current RAT type of end device 130.

When the subscription storage device of the first RAT type determines that end device 130 is connected via the first RAT type (block 1115-YES), the subscription storage device of the first RAT type may generate and transmit a first response indicating the first RAT type to the requesting network device (e.g., an AF) (block 1120). For example, in block 1125, AF 202 may apply the current RAT type data (e.g., the first RAT type) to a network operation or procedure, as described herein.

When the subscription storage device of the first RAT type determines that end device 130 is not connected via the first RAT type (block 1115—NO), the subscription storage device of the first RAT type may generate and transmit a second request to a subscription storage device of a second RAT type for the current RAT type of end device 130 (block 1130).

In block 1135, the subscription storage device of the first RAT type may receive a first response indicating that end device 130 is connected via the second RAT type or is absent. In block 1140, the subscription storage device of the first RAT type may transmit a second response indicating the second RAT type or an absence to the requesting network device (e.g., the AF). In block 1145, AF 202 may apply the current RAT type data (e.g., the second RAT type or no RAT type (e.g., the absence) to a network operation or procedure, as described herein.

FIG. 11 illustrates an exemplary process 1100 of the RAT type monitoring event service, however, according to other exemplary embodiments, the RAT type monitoring event service may perform additional operations, fewer operations, and/or different operations than those illustrated and described in relation to FIG. 11.

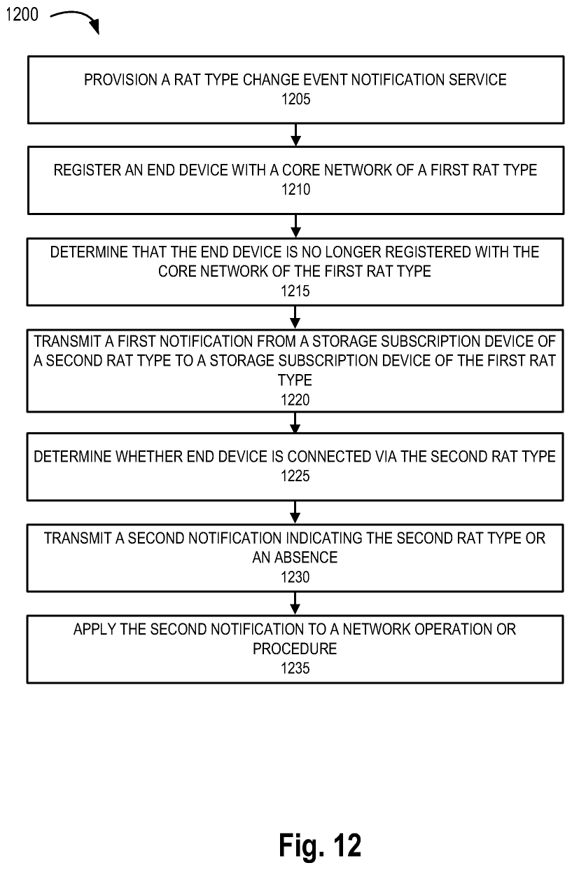

FIG. 12 is a flow diagram illustrating an exemplary process 1200 of an exemplary embodiment of the RAT type monitoring event service. According to an exemplary embodiment, core devices 122 may perform operations of process 1100. For example, subscription storage devices associated with a first and a second RAT type, such as HSS 206, UDM 304, UDR 306, HSS-FE 502, or the like, may perform operations or steps of process 1200. According to an exemplary implementation, processor 1010 executes software 1020 to perform a step (in whole or in part) of process 1200, as described herein. Alternatively, a step (in whole or in part) may be performed by execution of only hardware. For purposes of description only, operations of process 1200 are described as being performed by a subscription storage device of a first RAT type and a subscription storage device of a second RAT type. Process 1200 may include operations illustrated and described in relation to FIGS. 6-9 and elsewhere in the description.

In block 1205, the subscription storage device of the first RAT type may provision a RAT type change event notification service. For example, the RAT type change event notification service may be associated with a subscription of an AF, such as AF 202.

In block 1210, the subscription storage device of the first RAT type may store information indicating that end device 130 is registered with a core network of the first RAT type.

In block 1215, the subscription storage device of the second RAT type may determine that end device 130 is no longer registered with the core network. For example, the subscription storage device of the second RAT type may receive a notification from core device 122 of a core network of the second RAT type that end device 130 has deregistered with the core network of the first RAT type.

In block 1220, the subscription storage device of the second RAT type may transmit a first notification to the subscription storage device of the first RAT type. For example, the notification may be implemented as a deregistration message, as described herein.

In block 1225, the subscription storage device of the second RAT type may determine whether end device 130 is connected via the second RAT type.

In block 1230, the subscription storage device of the second RAT type may generate and transmit a second notification indicating that the second RAT type or an absence of end device 130.

In block 1235, the AF may apply the second notification to a network operation or a procedure, as described herein. For example, the current RAT type data, which may indicate the second RAT type or an absence of end device 130, may be applied to one or multiple operations and/or procedures of the AF, as described herein.

FIG. 12 illustrates an exemplary process 1200 of the RAT type monitoring event service, however, according to other exemplary embodiments, the RAT type monitoring event service may perform additional operations, fewer operations, and/or different operations than those illustrated and described in relation to FIG. 12.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the processes illustrated in FIGS. 11 and 12, the order of the blocks may be modified according to other embodiments. Further, non-dependent blocks may be performed in parallel. Additionally, other processes (e.g., FIGS. 2, 3, etc.) described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 1010, etc.), or a combination of hardware and software (e.g., software 1020).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 1010) of a device. A non-transitory storage medium includes one or more of the storage mediums described in relation to memory/storage 1015. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a subscription storage device of a first radio access technology (RAT) type from a first network device, a first request for a current RAT type of an end device;
determining, by the subscription storage device in response to the first request, whether the end device is connected to a network via the first RAT type; and
transmitting, by the subscription storage device to the first network device, a first response indicating the first RAT type when the subscription storage device determines that the current RAT type is the first RAT type.

2. The method of claim 1, further comprising:
applying first RAT type data indicative of the current RAT type of the end device to a network operation or procedure.

3. The method of claim 1, further comprising:
transmitting, by the subscription storage device to a subscription storage device of a second RAT type, a second request for the current RAT type of the end device, when the subscription storage device determines that the current RAT type is not the first RAT type.

4. The method of claim 3, further comprising:
receiving, by the subscription storage device of the first RAT type from the subscription storage device of the second RAT type, a second response indicating that the current RAT type is the second RAT type or the end device is not connected; and
transmitting, by the subscription storage device of the first RAT type to the first network device, the second response.

5. The method of claim 4, further comprising:
applying second RAT type data or data that the end device is not connected, which is indicative of the current RAT type of the end device, to a network operation or procedure.

6. The method of claim 5, wherein the network operation pertains to an establishment of a first application session between the first network device and the end device, or a modification of an active second application session between the first network device and the end device.

7. The method of claim 1, wherein the first network device includes an application function (AF) that hosts an application service external from a core network of the subscription storage device of the first RAT type.

8. The method of claim 1, wherein the subscription storage device of the first RAT type includes a home subscriber server (HSS), an HSS front end (HSS-FE), or a unified data management (UDM).

9. A system comprising:
a subscription storage device of a first radio access technology (RAT) type, wherein the subscription storage device comprises a first processor that is configured to:
receive from a first network device, a first request for a current RAT type of an end device;
determine in response to the first request, whether the end device is connected to a network via the first RAT type; and
transmit to the first network device, a first response indicating the first RAT type when the subscription storage device determines that the current RAT type is the first RAT type.

10. The system of claim 9, further comprising:
the first network device, wherein the first network device comprises a second processor configured to:
apply first RAT type data indicative of the current RAT type of the end device to a network operation or procedure.

11. The system of claim 9, wherein the first processor is further configured to:
transmit to a subscription storage device of a second RAT type, a second request for the current RAT type of the end device, when the subscription storage device of the first RAT type determines that the current RAT type is not the first RAT type.

12. The system of claim 11, wherein the first processor is further configured to:
receive from the subscription storage device of the second RAT type, a second response indicating that the current RAT type is the second RAT type or the end device is not connected; and
transmit to the first network device, the second response.

13. The system of claim 12, further comprising:
the first network device, wherein the first network device comprises a second processor configured to:
apply second RAT type data or data that the end device is not connected, which is indicative of the current RAT type of the end device, to a network operation or procedure.

14. The system of claim 13, wherein the network operation pertains to an establishment of a first application session between the first network device and the end device, or a modification of an active second application session between the first network device and the end device.

15. The system of claim 9, wherein the first network device includes an application function (AF) that hosts an application service external from a core network of the subscription storage device of the first RAT type.

16. The system of claim 9, wherein the subscription storage device of the first RAT type includes a home subscriber server (HSS), an HSS front end (HSS-FE), or a unified data management (UDM).

17. A non-transitory computer-readable storage medium storing instructions executable by a processor of a subscription storage device of a first radio access technology (RAT) type, wherein the instructions are configured to:
receive from a first network device, a first request for a current RAT type of an end device;
determine in response to the first request, whether the end device is connected to a network via the first RAT type; and
transmit to the first network device, a first response indicating the first RAT type when the subscription storage device determines that the current RAT type is the first RAT type.

18. The non-transitory computer-readable storage medium of claim 17, wherein the instructions are further configured to:
transmit to a subscription storage device of a second RAT type, a second request for the current RAT type of the end device, when the subscription storage device of the first RAT type determines that the current RAT type is not the first RAT type.

19. The non-transitory computer-readable storage medium of claim 18, wherein the instructions are further configured to:
receive from the subscription storage device of the second RAT type, a second response indicating that the current RAT type is the second RAT type or the end device is not connected; and
transmit to the first network device, the second response.

20. The non-transitory computer-readable storage medium of claim 17, wherein the subscription storage device of the first RAT type includes a home subscriber server (HSS), an HSS front end (HSS-FE), or a unified data management (UDM).
